(19) United States
(12) Patent Application Publication
(10) Pub. No.: US 2014/0265628 A1
(43) Pub. Date: Sep. 18, 2014

(54) FEED LINE-COMPENSATED POWER TRANSMISSION APPARATUS

(71) Applicants: Seong Jeub Jeon, Busan (KR); Dong Ho Cho, Seoul (KR); Jae Gue Shin, Daejeon (KR); Sung Jun Son, Jeonju (KR); Bo Yune Song, Seoul (KR); Byung O Kong, Busan (KR); Young Moo Shin, Daejeon (KR); Jin Hyuk Jang, Daejeon (KR); Dae Won Seo, Daejeon (KR)

(72) Inventors: Seong Jeub Jeon, Busan (KR); Dong Ho Cho, Seoul (KR); Jae Gue Shin, Daejeon (KR); Sung Jun Son, Jeonju (KR); Bo Yune Song, Seoul (KR); Byung O Kong, Busan (KR); Young Moo Shin, Daejeon (KR); Jin Hyuk Jang, Daejeon (KR); Dae Won Seo, Daejeon (KR)

(73) Assignee: Korea Advanced Institute of Science and technology, Daejeon (KR)

(21) Appl. No.: 14/114,342

(22) PCT Filed: Apr. 30, 2012
(86) PCT No.: PCT/KR12/03360

§ 371 Date: Apr. 16, 2014

(30) Foreign Application Priority Data
Apr. 29, 2011 (KR) 10-2011-0040934

(51) Int. Cl. H02J 3/00

(52) U.S. Cl. CPC H02J 3/00
USPC 307/109

(57) ABSTRACT

One embodiment of the present invention discloses a feed line-compensated power transmission apparatus. One embodiment of the present invention, comprises: a feed line provided with horizontally elongated first and second lines and a third line for connecting one end of the first line to one end of the second line; a pair of compensation capacitors which are placed to face each other by connecting one end of the compensation capacitor to the other end of the first line and one end of the other compensation capacitor to the other end of the second line; an input power source for applying a high frequency power source by connecting both ends of the input power source to the other ends of the pair of compensation capacitors, respectively.

### TECHNICAL FIELD

An embodiment of the present invention relates to a feed line-compensated power transmission apparatus. More particularly, an embodiment of the present invention relates to a feed line-compensated power transmission apparatus which limits voltage to ground to be less than residual voltage by compensating the voltage to ground of a line transmitting AC power.

### DESCRIPTION OF RELATED ART

The matters described in this section are intended to simply provide background information for an embodiment of the present invention and do not constitute conventional technology.

Drawing 1 shows an electric vehicle traveling on the road while being supplied with power from a feed line laid under the road.

As shown in Drawing 1, when a high frequency power is supplied to a feed line, an electric vehicle (100) traveling on the road is supplied with power necessary for traveling by the principle of electromagnetic induction between a feed line (120) and a current collector (110).

Drawing 2 shows a power transmission apparatus including the current collector (110), the feed line (120) and an input power source (230) viewed in an X direction of Drawing 1, excluding the vehicle.

For an apparatus which supplies power of frequency much higher than commercial frequency, such as a power transmission apparatus of the online electric vehicle (100), impedance by inductance of the feed line (120) increases and the effect on the power transmission apparatus also increases proportionately. As one of the methods to minimize the effect of impedance by inductance of a feed line on a power transmission apparatus, a capacitor (240) may be connected in series adjacent to the input power source (230) on the feed line (120) to compensate impedance of the inductance component of the feed line generated by high frequency generated from the input power source (230).

However, when the compensation method shown in Drawing 2 is used, the absolute value of voltage to ground increases towards a Y direction (counterclockwise) with the grounding point A on the feed line (120) and becomes the maximum at the point B contact with the capacitor (240). Therefore, if the feed line (120) is exposed for various reasons such as deterioration of the feed line (120) or accidents near the feed line (120), the voltage to ground increased more than a certain level for the location of the feed line (120) may threaten the safety of person or other mechanical devices.

### DESCRIPTION OF THE INVENTION

### Technical Task

In order to solve these problems, the first purpose of an embodiment of the present ^{invention} is to limit the voltage to ground of the line transmitting AC power within limiting voltage

The second purpose of an embodiment of the present invention is to make the level of the voltage to ground on the feed line being distributed regularly by placing additional capacitors facing each other on the feed line at a regular interval.

The third purpose of an embodiment of the present invention is to minimize problems in maintenance by reducing the number of capacitors on the feed line, when terminal capacitors are added.

### Means to Solve the Task

In order to achieve the abovementioned purposes, the first embodiment of the present invention provides a feed line-compensated power transmission apparatus which includes a feed line provided with horizontally elongated first and second lines and a third line for connecting one end of said first line to one end of said second line, a pair of compensation capacitors which are placed to face each other by connecting one end of the compensation capacitor to the other end of said first line and one end of the other compensation capacitor to the other end of said second line, and an input power source for applying a high frequency power by connecting both ends of the input power source to the other end of said pair of compensation capacitors, respectively.

Said feed line-compensated power transmission apparatus may include a pair of additional line capacitors which are placed to face each other at a regular interval on said first line and said second line, respectively.

Said line capacitors placed to face each other may be equal in capacity.

Said third line connects said first line to said second line including terminal capacitors, and for said terminal capacitors, capacitors equal in capacity may be connected in series and the contact between said capacitors equal in capacity may be grounded.

Said pair of compensation capacitors may be equal in capacity.

The voltage levels at all of the points on said feed line may be less than a prescribed limiting voltage.

The inductance of said feed line may be less than a prescribed level.

When said feed line-compensated power transmission apparatus includes a pair of line capacitors placed to face each other at a regular interval on said first line and said second line, said pair of line capacitors placed to face each other are equal in capacity, and said third line connects said first line to said second line including terminal capacitors which are equal in capacity and connected in series, said line capacitors may be twice of the capacity of said terminal capacitors.

In order to achieve the abovementioned purposes, the second embodiment of the present invention provides a feed line-compensated power transmission apparatus which includes a feed line provided with horizontally elongated first and second lines and a third line for connecting one end of said first line to one end of said second line, multiple first compensation capacitors arranged spaced apart from each other at prescribed intervals on said first line, multiple second compensation capacitors arranged spaced apart from each other at prescribed intervals on said second line, and an input power source for applying a high frequency power by connecting the first compensation capacitor farthest away from said third line to the second compensation capacitor farthest away from said third line.

The sum of the separation distance between the nearest first compensation capacitor on said third line and said third line and the separation distance between the nearest second compensation capacitor on said third line and said third line may be said prescribed interval.

Said first compensation capacitor and said second compensation capacitor may be equal in capacity.

The voltage levels at all of the points on said feed line may be less than a prescribed limiting voltage.

The inductance of said feed line may be less than a prescribed level.

Said first compensation capacitor and said second compensation capacitor may be placed to face each other, respectively.

### Effect of the Invention

According to an embodiment of the present invention, first, it has an effect of limiting the voltage to ground of a line which transmits AC power within the limiting voltage.

It has another effect to regularly distribute the voltage to ground on a feed line by having more capacitors placed faced to each other at regular intervals on the feed line.

Also, if terminal capacitors are added, the number of the capacitors on the feed line may be reduced and maintenance problems may be minimized.

### BRIEF DESCRIPTION OF THE SEVERAL VIEW OF THE DRAWING

Drawing 1 shows an electric vehicle which travels on the road while being supplied with power from a feed line laid in the road.

Drawing 2 shows a power transmission apparatus which includes a current collector, a feed line, and an input power source viewed in an X direction of Drawing 1, excluding the vehicle.

Drawing 3 gives a conceptual illustration of an aspect of the feed line-compensation power transmission apparatus according to the first embodiment of the present invention laid under the road.

Drawing 4 illustrates the voltage generated from the points connecting each components of a feed line-compensated power transmission apparatus (300) and the voltage generated from the area (between the lines of A-A′ and of B-B′) beneath a current collector (310) on a feed line (320).

Drawing 5 illustrates the voltage and load voltage of the points connecting to each of the components.

Drawing 6 illustrates the distribution of voltage on the feed line when no load voltage exists in Drawing 5 (that is, when no power is transmitted to a current collector).

Drawing 7 illustrates a case where more than one line capacitor are arranged spaced apart from each other at regular intervals on a first line (322) and a second line (324).

Drawing 8 illustrates the distribution of the voltage between the A-A′, B-B′, and C-C′ on the first line (322).

Drawing 9 is a top view of the feed line-compensated power transmission apparatus according to the second embodiment of the present invention laid under the road.

### THE BEST FORM FOR AN EMBODIMENT OF THE INVENTION

From now on, a desired embodiment of the present invention will be explained in detail on reference to the attached drawings. Note that the same components in the drawings are indicated by the same reference numbers and symbols as much as possible, although they are shown in different drawings. If a detailed explanation of related function or configuration is considered to unnecessarily obscure the gist of the present invention, such a detailed explanation will be omitted.

In addition, such terms as ‘the first’, ‘the second’, ‘A’, ‘B’, ‘(a)’, and ‘(b)’ may be used in explaining the components of the present invention. These terms are simply intended to distinguish the corresponding component from others but do not limit the nature, sequence or order of the corresponding component. When it is described that one component is “connected”, “combined”, or “accessed” to another component, it should be understood that the former can be directly connected or accessed to the latter but the third component may be “connected”, “combined”, or “accessed” between each of the components.

Drawing 3 gives a conceptual illustration of an aspect of the feed line-compensation power transmission apparatus according to the first embodiment of the present invention laid under the road.

As illustrated in Drawing 3, the feed line-compensated power transmission apparatus (300) according to the first embodiment of the present invention includes the feed line (320) consisting of the first line (322), the second line (324), and a third line (326), an input power source (330), and a pair of compensation capacitors (341, 342). For convenience' sake, a line placed in the top of the drawing is called the first line (322), a line placed in the bottom of the drawing is called the second line (324), and the end part (the right end part of the circuit) connecting the first line (322) to the second line (324) is called the third line (326).

The feed line (320) has the elongated first line (322) and second line (324) and connects one end of the third line (326) to one end of the first line (322) (X′) and the other end of the third line (326) and one end of the second line (324) (Y′).

One end of the first compensation capacitor (341) is connected to the other end of the first line (322) (X), and one end of the second compensation capacitor (342) is connected to the other end of the second line (324) (Y). In this case, when the first compensation capacitor (341) is placed at the top and the second compensation capacitor (342) placed at the bottom, the first compensation capacitor (341) and the second compensation capacitor (342) face to each other. In this case, it is desirable that the compensation capacitors (341, 342) placed facing to each other are equal in capacity.

Mean while, the input power source (330) for applying a high frequency power is connected between the other end of the first compensation capacitor (341) and the other end of the second compensation capacitor (342) (A and A′). When the input power source (330) is connected, the input power source (330), the compensation capacitors (341, 342) and the feed line (320) form a closed circuit.

In addition, the third line (326) may connect the first line (322) to the second line (324) including terminal capacitors (343, 344). The terminal capacitor may be one capacitor with the capacity of C_{end} or the form of series connection of the first terminal capacitor (343) and the second terminal capacitor (344) (that is, the first terminal capacitor (343) and the second terminal capacitor (344) with the capacity of 2*C_{end} respectively). As shown in Drawing 3, with grounding of the contact to which the first terminal capacitor (343) and the second terminal capacitor (344) are connected in series (that is, the point G connecting one end of the first terminal capacitor (343) and the second terminal capacitor (344)), the other end of the first terminal capacitor (343) may be connected to the first line (322) and the other end of the second terminal capacitor (344) connected to the second line (324).

The feed line (320) may be covered by insulating materials and laid under the road. The compensation capacitors (341, 342) and the terminal capacitors (343, 344) may be treated with soil-resistance finish and water-proofing and connected to the feed line (320) and laid under the road, respectively, In this case, it is advantageous that by arranging the first compensation capacitor (341) and the second compensation capacitor (342) facing to each other, not only both compensation capacitors can be laid under the road with one laying work but also the optimum number of capacitors can be used to maintain the after-mentioned voltage to ground of the feed line (320) within a prescribed limiting voltage.

Drawing 4 illustrates the voltage generated from the points connecting each components of the feed line-compensated power transmission apparatus (300) and the voltage generated from the area (between the lines of A-A′ and of B-B′) beneath the current collector on the feed line (320).

The voltage should be limited so that the absolute value at any point on the feed line (320) of the feed line-compensated power transmission apparatus should be less than a prescribed limiting voltage (Vₗᵢₘ).

In the circuit configuration of Drawing 4, the voltages of the first line (322) of increasing voltage and the second line (324) of decreasing voltage are equal in absolute values but opposed to each other in symbol as they get close to the input power source from the grounding point, because the circuit components on the feed line (320) are symmetrical to each other. Therefore, when the absolute values of the voltage to ground are analyzed, the capacity of the voltage applied to the first line (322) and circuit components will be analyzed but the analysis for the second line (324) will be omitted.

From now on, equations will be used to analyze the voltage applied to the first line (322) and required capacity of the circuit components.

In Drawing 4, the voltage (V_{end}) at the other end of the first terminal capacitor (343) on the feed line (320) is determined by Equation (1).

$${V}_{end} = \frac{1}{2} \frac{1}{j 2 π {fC}_{end}} I \qquad Equation ( 1 )$$

(where f=frequency of the input power source
C=capacity of a terminal capacitor
I=level of feeding current)

Because V_{end} of Equation 1 should be less than limiting voltage (Vₗᵢₘ), it satisfies Equation 2.

$${V}_{end} = \frac{I}{4 π {fC}_{end}} \leq {V}_{lim} \qquad Equation 2$$

Therefore, from Equations (1) and (2), the capacity of the entire terminal capacitor (a body connecting 343 and 344 in series) is determined so as to satisfy Equation (3).

$${C}_{end} \geq \frac{I}{4 π {fV}_{lim}} \qquad Equation ( 3 )$$

Meanwhile, when the inductance of the first line (322) is L_{track} and the sum of the voltages generated from the section of the feed line (320) (A-A′ and B-B′) beneath a current collector installed in a vehicle traveling on the first line (322) is V_{load,} the voltage generated from the line of A-A′ is V_{load}/2, if it is designed that the voltages generated by the current collector from A-A′ and B-b′ are symmetrical. Therefore, the voltage at the right end of the first compensation capacitor (341), Vₛₜ, is computed from Equation (4).

$${V}_{st} = {V}_{end} + j π {fL}_{track} I + \frac{{V}_{load}}{2} \qquad Equation ( 4 )$$

As being the voltage by the capacitance (2*C_{end}), V_{end} of Equation (4) should be opposed to the voltage by the inductance of the first line (322), jπfL_{track}I, in phase and Vₛₜ should be less than a prescribed limiting voltage (Vₗᵢₘ) and satisfy Equation (5).

$${V}_{st}^{2} = {( {V}_{end} - π {fL}_{track} I )}^{2} + \frac{{V}_{load}^{2}}{4} \leq {V}_{lim}^{2} \qquad Equation ( 5 )$$

The inductance of the first line (322), L_{track}, of Equation (5) satisfies Equation (6).

$${L}_{track} \leq \frac{\sqrt{{V}_{lim}^{2} - \frac{{V}_{load}^{2}}{4}} + {V}_{end}}{π fI} \qquad Equation ( 6 )$$

Therefore, as expressed in Equation (6), the inductance of the first line (322) should be less than a prescribed level.

The voltage between the connecting point of the input power source (330) and the first compensation capacitor (341) and the grounding point (i.e., the earth) is calculated from Equation (7).

$${V}_{c} = {V}_{st} + \frac{I}{j 2 π {fC}_{c}} \qquad Equation ( 7 )$$

(where C_{c}=capacity of the first compensation capacitor (341))

Meanwhile, the value for the grounding point of the connecting point of the input power source (330) and the first compensation capacitor (341) upon no load, V_{c}_{_{—}}ₙₒ, is calculated from Equation (8).

$${V}_{c\_no} = π {fL}_{track} I - {V}_{end} - \frac{I}{2 π {fC}_{c}} = ( π {fL}_{track} - \frac{1}{4 π {fC}_{end}} - \frac{1}{2 π {fC}_{c}} ) I \qquad Equation ( 8 )$$

Therefore, the equivalent impedance (Lₑ) of the present driving point at both ends of the input power source (330) using Equation (8) is computed from Equation (9).

$${L}_{e} = \frac{2 {V}_{c\_no}}{2 π fI} = {L}_{track} - \frac{1}{{( 2 π f )}^{2} {C}_{end}} - \frac{2}{{( 2 π f )}^{2} {C}_{c}} \qquad Equation ( 9 )$$

From Equation (9), the capacity (C_{c}) of the first compensation capacitor is written as Equation (10):

$${C}_{c} = \frac{I}{2 π f ( π {fL}_{track} I - {V}_{end} - {V}_{C\_no} )} \qquad Equation ( 10 )$$

Drawing 5 illustrates the voltage and load voltage of the points connecting to each of the components in Drawing 4.

For instance, when feeder current I=200 A, limiting voltage Vₗᵢₘ=600V, no-load operating voltage 2V_{c}_{_{—}}ₙₒ=300V, no-load voltage V_{load}=400V, and operating frequency f=20 kHz, the capacity of the first terminal capacitor (343) is calculated from Equation (3) as C_{end}=I/(4πfVₗᵢₘ)=200/(4π*20 k*600)=1.33 μF. Therefore, the voltage at both ends of the first terminal capacitor (343) is calculated from Equation (2) as V_{end}=200/(4π*20 k*1.5μ)=531V, which is less than limiting voltage of 600V. In this case, the inductance of the first line (322) which can be operated within the range of limiting voltage can be calculated from Equation (11) based on Equation (6).

$${L}_{track} \leq \frac{\sqrt{{V}_{lim}^{2} - \frac{{V}_{load}^{2}}{4}} + {V}_{end}}{π fI} = \frac{\sqrt{{600}^{2} - \frac{{400}^{2}}{4}} + 531}{π \times 20 k \times 200} = 87 [ μ H ] \qquad Equation ( 11 )$$

If the inductance of the first line (322) is 80 μH so as to satisfy (L_{track}≦87 μH) in Equation (11), the voltage at the right end of the first compensation capacitor (341), Vₛₜ is calculated from Equation (12) based on Equation (5).

$$\begin{matrix}{V}_{st}^{2} = {( {V}_{end} - π {fL}_{track} I )}^{2} + \frac{{V}_{load}^{2}}{4} \\ = {( 531 - π \times 20 k \times 80 μ \times 200 )}^{2} + \frac{{400}^{2}}{4}\end{matrix} \\ {V}_{st} = 515 \leq {V}_{lim} \qquad Equation ( 12 )$$

Therefore, the capacity of the first compensation capacitor (341) to get required no-load operating voltage is calculated from Equation (13) based on Equation (10).

$$\begin{matrix}{C}_{c} = \frac{I}{2 π f ( π {fL}_{track} I - {V}_{end} - {V}_{C\_no} )} \\ = \frac{200}{2 π \times 20 k ( π \times 20 k \times 80 μ \times 200 - 531 - 150 )} \\ = 4.91 [ μ F ]\end{matrix} \qquad Equation ( 13 )$$

If the first compensation capacitor (341) is configured to get the value similar to 4.91 μF calculated from Equation (13) by a parallel connection of a 4.7 μF capacitor and a 0.2 μF capacitor, an actual no-load operating voltage (2V_{c}_{_{—}}ₙₒ) can be calculated from Equation (14) based on Equation (8)

$$\begin{matrix}2 {V}_{c\_no} = 2 ( π {fL}_{track} I - {V}_{end} - \frac{I}{2 π {fC}_{c}} ) \\ = 2 ( π \times 20 k \times 80 μ \times 200 - 531 - \frac{200}{2 π \times 20 k \times 4.9 μ} ) \\ = 299 [ V ]\end{matrix} \qquad Equation ( 14 )$$

Therefore, as shown in Drawing 5, it is possible to design the voltage at each of the terminal on the feed line (320) for 200 A of feeder current and 400V of load voltage to be less than limiting voltage.

Drawing 6 illustrates the distribution of voltage on the feed line (320) from the point of X to the point of X′ in Drawing 5 if there load voltage does not exist (that is, no power is transmitted to a current collector).

As illustrated in Drawing 6, the voltage on the feed line (320) is linearly changed and no point on the feed line (320) has voltage over 600V, limiting voltage.

Drawing 7 illustrates a case where more than one line capacitors are arranged at regular intervals on the first line (322) and the second line (324).

As illustrated in Drawing 7, more than one first line capacitors (345, 346) and more than one second line capacitors (347, 348) can be installed additionally on the first line (322) and the second line (324) placed to face each other at regular intervals, respectively. In this case, it is desirable that the first line capacitors (345, 346) and the second line capacitors (347, 348) placed to face each other are equal in capacity.

Although two pairs of the first line capacitors (345, 346) and the second line capacitors (347, 348) are illustrated in Drawing 7, one pair, two pairs, or three pairs of line capacitors may exist at facing points in actual. That is, if the voltage to ground of the feed line (320) cannot be maintained within a prescribed limiting voltage only with a pair of compensation capacitors (341, 342) because the first line (322) and the second line (324) are long, the first line capacitor (345) and the second line capacitor (347) are added. If it is not possible to maintain the voltage within ground within a prescribed limiting voltage by adding one first line capacitor (345) and one second line capacitor (347), one first line capacitor (346) and one second line capacitor (348) may be added to maintain the voltage to ground of the feed line (320) within a prescribed limiting voltage.

*Drawing 8 illustrates the distribution of the voltage between A and A′, B and B′, and C and C′ on the first line (322).

As shown in Drawing 8, the voltage increases by the effect of the inductance of the first line (322) towards the input power source (330) from the third line (326) (the point of C′) on the first line (322).

Meanwhile, if the third line (326) is provided with the terminal capacitors (343, 344), it does not need to add one line capacitor on the first line (322) and the second line (324), respectively, compared to a case where there are no terminal capacitors (343, 344). In this case, it is advantageous that terminal capacitors (343, 344) with small capacity can be used instead of line capacitors with high capacity.

As shown in Drawing 8, the feed line (320) should be provided with line capacitors of same capacity (345, 346, 347, and 348) at regular intervals so as to generate voltage in regular distribution. Also, it is desirable that the line capacitors (345, 346, 347 and 348) are twice the capacity of the terminal capacitors (343, 344), respectively.

Drawing 9 gives a conceptual aspect which the feed line-compensated power transmission apparatus according to the second embodiment of the present invention is laid under the road.

As shown in Drawing 9, the feed line-compensated power transmission apparatus (900) according to the second embodiment of the present invention includes a feed line (920), an input power source (930), multiple first compensation capacitors (941, 942) and multiple second compensation capacitors (943, 944).

The feed line (920) is provided with a first line (922), a second line (924), and a third line (926) which connects one end of the first line (922) and one end of the second line (924).

Multiple first compensation capacitors (941, 942) are connected to the first line (922) spaced apart from each other at a prescribed interval and multiple second compensation capacitors (943, 944) are connected to the second line (922) spaced apart from each other at the same prescribed interval. That is, the interval between the first compensation capacitors (941, 942) and the second compensation capacitors (943, 944) may be same.

Also, the first compensation capacitors (941, 942) and the second compensation capacitors (943, 944) may be placed to face each other, respectively.

In Drawing 9, the input power source (930) applies a high frequency power by connecting the first compensation capacitor (941) on the first line (922) farthest from the third line (926) and the second compensation capacitor (943) on the second line (924) farthest from the third line (926).

In this case, the sum of the interval between the nearest first compensation capacitor (942) on the third line (926) and the third line (926) and the interval between the nearest second compensation capacitor (944) on the third line (926) and the third line (926) may be same as the interval between either of multiple first compensation capacitors (941, 942).

Also, it is desirable that the first compensation capacitors (941, 942) and the second compensation capacitors (943, 944) are equal in capacity.

In the second embodiment, the level of absolute values of the voltage at all of the points on the feed line (920) can be maintained to be less than a prescribed limiting voltage (Vₗᵢₘ) by selecting the interval between capacitors, the capacity of the capacitors, and the inductance of the feed line (920) in a way similar to the first embodiment.

Because the terms of “include”, “consist of”, or “have” stated above mean that unless otherwise specified, the applicable components can be included, they should be construed as including other components, not as excluding them. All the terminology including technical or scientific terms, unless otherwise defined, have the same meanings as being generally understood by those who have common knowledge in the related art of the present invention. Terms in general use, like those defined in a dictionary, should be construed as coinciding with the meaning of the context of related art and unless obviously defined in the present invention, should not construed as having excessively formal meanings.

The abovementioned discussion is merely an adumbrative explanation of the technical philosophy of the present invention and anyone who has common knowledge of the related art of the present invention may alter or change in various ways within the range not deviated from the intrinsic nature of the present invention. Therefore, the embodiments of the present invention are not to limit but to explain the technical philosophy of the present invention, and the range of the technical philosophy of the present invention is not limited by the embodiments. The protection range of the present invention should be construed under the scope of claims below, and the entire technical philosophy within the same range should be construed as being included in the scope of rights of the present invention.

### AVAILABILITY IN THE RELATED INDUSTRY

As abovementioned, the present invention is a useful invention in that it has an effect to limit the voltage to ground of the line transmitting AC power within limiting voltage.

### CROSS-REFERENCE TO RELATED APPLICATION

If priority is argued for the Patent No. 10-2011-004934 which was applied in Korea on Apr. 29, 2011 according to Article 119 (a) of the United States Code (35 U.S.C §119(a)), all the contents will be merged to the present patent application as reference. In addition, if priority is argued for the present patent application in other countries than the United States for the same reasons as above, all the contents will be merged into the present patent application.

What is claimed is:

1. A feed line-compensated power transmission apparatus which includes a feed line provided with a first line and a second line and a third line for connecting one end of said first line to one end of said second line, a pair of compensation capacitors placed to face each other by connecting one end of the compensation capacitor to the other end of said first line and one end of the other compensation capacitor to the other end of said second line, and an input power source for applying a high frequency power with both ends of said pair of compensation capacitors.

2. The feed line-compensated power transmission apparatus as claim 1, wherein said feed line-compensated power transmission apparatus includes a pair of additional line capacitors which are placed to face each other at a regular interval on said first line and said second line, respectively.

3. The feed line-compensated power transmission apparatus as claim 1, wherein said line capacitors placed to face each other are equal in capacity.

4. The feed line-compensated power transmission apparatus as claim 1, wherein said third line includes terminal capacitors to which capacitors equal in capacity are connected in series and the contact between said capacitors is grounded.

5. The feed line-compensated power transmission apparatus as claim 1, wherein said pair of compensation capacitors are equal in capacity.

6. The feed line-compensated power transmission apparatus as claim 1, wherein the voltage levels at all of the points on said feed line are less than a prescribed limiting voltage.

7. The feed line-compensated power transmission apparatus as claim 1, wherein the inductance of said feed line is less than a prescribed level.

8. The feed line-compensated power transmission apparatus as claim 1, wherein said feed line-compensated power transmission apparatus includes a pair of line capacitors placed to face each other at a regular interval on said first line and said second line, said pair of line capacitors placed to face each other are equal in capacity, and said third line connects said first line to said second line including terminal capacitors which are equal in capacity and connected in series, said line capacitors are twice the capacity of said terminal capacitors.

9. A feed line-compensated power transmission apparatus which includes a feed line provided with first and second lines and a third line for connecting one end of said first line to one end of said second line, multiple first compensation capacitors arranged spaced apart from each other at prescribed intervals on said first line, multiple second compensation capacitors arranged spaced apart from each other at prescribed intervals on said second line, and an input power source for applying a high frequency power by connecting the first compensation capacitor farthest away from said third line to the second compensation capacitor farthest away from said third line.

10. The feed line-compensated power transmission apparatus as claim 9, wherein the sum of the separation distance between the nearest first compensation capacitor on said third line and said third line and the separation distance between the nearest second compensation capacitor on said third line and said third line may be said prescribed interval.

11. The feed line-compensated power transmission apparatus as claim 9, wherein said first compensation capacitor and said second compensation capacitor are equal in capacity.

12. The feed line-compensated power transmission apparatus as claim 9, wherein the voltage levels at all of the points on said feed line are less than a prescribed limiting voltage.

13. The feed line-compensated power transmission apparatus as claim 9, wherein the inductance of said feed line is less than a prescribed level.

14. The feed line-compensated power transmission apparatus as claim 9, wherein said first compensation capacitor and said second compensation capacitor may be placed to face each other, respectively.
